(19) United States
(12) Patent Application Publication
(10) Pub. No.: US 2007/0090207 A1
(43) Pub. Date: Apr. 26, 2007

(54) Dosing device

(76) Inventor: Grant Chapman Ewan, Midrand (ZA)

Correspondence Address: JOHN S. PRATT, ESQ;KILPATRICK STOCKTON, LLP, 1100 PEACHTREE STREET, ATLANTA, GA, 30309, US

(21) Appl. No.: 10/596,229

(22) PCT Filed: Sep. 9, 2004
(86) PCT No.: PCT/IB04/02926

§ 371 Date: Aug. 21, 2006

(30) Foreign Application Priority Data
Dec. 5, 2003 (ZA) 2003/09466

(51) Int. Cl. E03C 1/08; B05B 7/30; B05B 7/26; B05B 7/12

(52) U.S. Cl. 239/428.5; 239/310; 239/318; 239/407

(57) ABSTRACT

The invention concerns a dosing device (10) comprising a conduit (14) for conveying a main liquid stream. The conduit has a first inlet (16), an outlet (18) and a zone (20) of reduced cross-section between the inlet and outlet. A passage (42, 44) extends between the zone and atmosphere and there is a control valve (30) operable, when the main stream is to be to be dosed with a dosing liquid, to close the passage such that a relatively low pressure is generated in the zone when the main liquid stream flows from the first inlet to the outlet through the zone. There is a second inlet (22) through which the dosing liquid can be drawn into the low pressure zone to mix with the main liquid stream and form a mixed stream. In addition there is an aerator located in the conduit downstream of the venturi to receive air through the outlet and introduce it into the mixed stream.

### BACKGROUND TO THE INVENTION

THIS invention relates to a dosing device.

In certain applications it is necessary to introduce one liquid into a flow of another liquid. A typical example is in commercial catering enterprises, such as hotels or restaurants, where it is desirable periodically to introduce liquid detergent into a flow of water which is to be used for washing up crockery, cutlery and so on.

Dosing devices for applications such as this have been proposed in the past and are widely used. However, a frequent problem with known dosing devices is an inability to achieve satisfactory mixing of the dosing liquid with the main liquid stream. Another problem may be an inability to permit easy adjustment of the amount of dosing liquid which is introduced into the main stream.

It is an object of this invention to provide a novel dosing device for such applications.

### SUMMARY OF THE INVENTION

According to the invention there is provided a dosing device comprising a conduit for conveying a main liquid stream and having a first inlet, an outlet and a zone of reduced cross-section between the inlet and outlet, a passage between the said zone and atmosphere, a control valve operable, when the main stream is to be to be dosed with a dosing liquid, to close the passage such that a relatively low pressure zone is generated in the zone when the main liquid stream flows from the first inlet to the outlet through the zone, a second inlet through which the dosing liquid can be drawn into the low pressure zone to mix with the main liquid stream and form a mixed stream, and an aerator, located in the conduit downstream of the venturi, to receive air through the outlet and introduce it into the mixed stream.

The control valve may include a push-button depressible to seat a valve closure on a seat, thereby to close the passage.

The aerator serves the important functions of aerating the mixed stream and of promoting good mixture between the main liquid and the dosing liquid. The outlet may be spanned, downstream of the aerator, by a mesh gauze.

Further according to the invention, the second inlet includes an inlet nipple or spigot to which a hose leading from a source of the dosing liquid can be connected, and a flow control nozzle which is fitted releasably to the inlet spigot to control the flow of dosing liquid therethrough and over which the hose is connected to the spigot.

Still further according to the invention, the first inlet is threaded for connection to a faucet and the conduit has an outer surface formed with spanner-engagable flats to facilitate threaded connection of the first inlet to the faucet. Typically, the conduit is formed in body having an outer surface formed with spanner-engagable flats to facilitate threaded connection of the first inlet to the faucet.

### BRIEF DESCRIPTION OF THE DRAWINGS

The invention will now be described in more detail, by way of example only, with reference to the accompanying drawings.

In the drawings:

FIG. 1 shows a cross-sectional view of a dosing device according to the invention; and

FIG. 2 shows a cross-section at the line 2-2 in FIG. 1; and

FIG. 3 shows a cross-sectional view of a portion of a modified device.

### DESCRIPTION OF THE ILLUSTRATED EMBODIMENTS

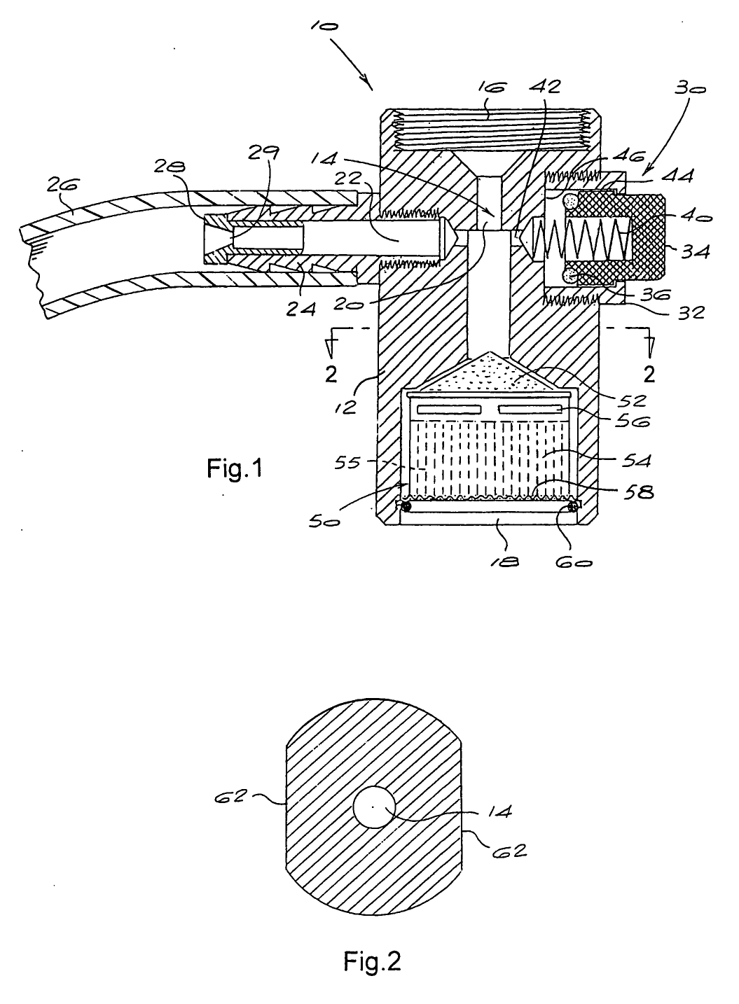

The dosing device 10 seen in FIG. 1 includes a main body 12 defining a conduit 14 having a first inlet 16 and an outlet 18. The first inlet 16 is internally threaded as shown for connection to a standard water faucet, typically a faucet serving a sink, basin or other receptacle in which washing up takes place in a commercial catering enterprise.

Between the first inlet 16 and the outlet 18 the cross-sectional area of the conduit is locally reduced to form a venturi throat 20. It will be understood that with a main liquid stream, in this case a water stream, flowing from the inlet 16 to the outlet 18, the venturi is capable of generating a low pressure zone in the conduit. More is said about this subsequently.

The venturi is intersected by a second inlet 22 defined by an inlet spigot or nipple 24 to which, in use, a hose 26 extending from a source of a dosing liquid (not shown) is connected. In the example mentioned above, the dosing liquid is typically a detergent which is to be mixed with the main water stream to provide a mixed liquid suitable for washing up crockery, cutlery and so on. In practice, the other end of the hose (not shown) will extend into a container of the dosing liquid.

Flow through the second inlet 22 is controlled by a flow control nozzle 28 fitted releasably as a friction fit into the end of the nipple 24. The nozzle has an internal orifice 29 through which flow of the dosing liquid must take place and may be of a commercially available type referred to as a dilution tip. The hose 26 fits over the dilution tip as illustrated.

The device 10 also includes a control valve indicated generally with the numeral 30. The valve 30 has a housing 32 in which a push-button 34 can slide. The inner end of the push-button carries an O-ring 36 and the push button itself is biased outwardly by a spring 40. When the push button is in the position seen in FIG. 1, the conduit 14 can communicate directly with atmosphere through a passage 42 and a gap 44 between the button 34 and the housing 32. This prevents the generation of a low pressure in the conduit in the vicinity of the venturi. However, when the button is depressed against the bias of the spring 40, such that the O-ring 36 seats on a surface 46 of the main body 12 which surrounds the passage 42, such communication with the atmosphere is terminated and water flow through the venturi generates a low pressure zone in the conduit 14. This low pressure draws a dose of the dosing liquid from the source, through the hose 26, dilution tip 28 and inlet 22 into the conduit 14 where it mixes with the main water flow. The introduction of dosing liquid carries on as long as the button 34 is depressed. The arrangement may in some embodiments be such that the low pressure generated by the venturi is sufficient to hold the button in the depressed position as long as the main water flow is maintained.

Located in the conduit 14 downstream of the venturi throat is an aerator 50. In this embodiment, the aerator is of a conventional type, specifically a Neoperi aerator cascade insert of Class B flowrate.

The aerator has a perforated, conical upper end 52 and a lower portion 54 formed with a series of narrow, longitudinal passages 55. Laterally extending slots 56 are formed in the side wall of the aerator between the upper end 52 and the lower portion 54 to admit air into the upper ends of the passages. The aerator 50 is a loose fit in the lower end of the conduit 14 and is held in place by a gauze mesh 58 and a circlip 60.

In use, with water flowing through the conduit 14 and the button 34 depressed such that low pressure is generated in the conduit 14, dosing liquid is drawn into the water flow to form a mixed stream which flows through the aerator 50. At the same time, air is drawn upwardly through the outlet 18, passes around the lower portion 54 of the aerator and enters the mixed flow through the slots 56 in the form of fine bubbles. The air accordingly mixes intimately with the mixed liquid flow in the narrow passages 55 through the aerator.

This has a dual advantage. Firstly, the mixed liquid flow is aerated and secondly, the introduction of the air bubbles into the liquid flow promotes thorough mixing between the main liquid, i.e. water and the dosing liquid, typically detergent.

Another advantage of the illustrated device 10 arises through the use of the dilution tip 28. It will be understood that for reasons of economy it is important to ensure that the correct amount of dosing liquid is added to the main liquid stream. The dilution tip 28 is one of a series of such tips which have different orifice sizes and which are accordingly designed to admit greater or lesser quantities of dosing liquid. Thus, for a given flow of main liquid it is possible to determine empirically which dilution tip 28 delivers the right amount of dosing liquid, and to install the correct dilution tip. The tip can of course be replaced as necessary to suit the particular circumstances. This is achieved quickly and simply merely by pulling the end of the hose off the nipple 24, pulling the existing tip out of the end of the nipple, pushing a new tip into the end of the spigot and pushing the hose back over the tip and nipple.

Referring to FIG. 2 it will be noted that the body 12 has opposing flat surfaces 62. These surfaces can be engaged by a spanner or like tool in order to screw the inlet 16 onto the threaded end of a faucet.

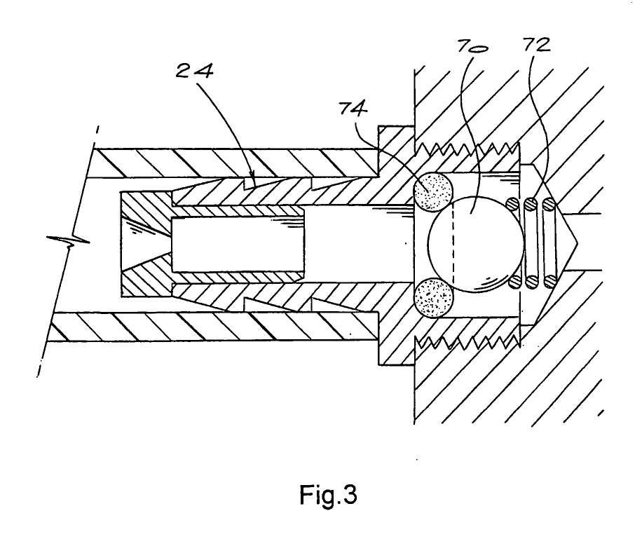

FIG. 3 shows a modified embodiment in which the nipple 24 includes a non-return valve including a ball 70 biased by a spring 72 against an O-ring seat 74.

When the venturi is operative, i.e. there is flow through the conduit 14 and the button 34 is depressed, the low pressure generated by the venturi is sufficient to unseat the ball from the O-ring, allowing the dosing liquid to bypass the ball and enter the main flow. When the main flow is terminated, for example by closure of the faucet, and the conduit 14 is once again in communication with atmosphere, the spring 72 seats the ball 70 against the O-ring and prevents liquid from flowing backwards through the nipple 24 and hose 26. With this feature, the hose is maintained full of dosing liquid and dosing of the main flow can commence as soon as the main flow is established and the button 34 is depressed, i.e. the hose 26 is kept in a primed condition ready for the next dosing operation.

Although specific mention has been made of the use of the dosing device in commercial operations, it will be understood that it could equally well be used in domestic applications.

1. A dosing device comprising a conduit for conveying a main liquid stream and having a first inlet, an outlet and a zone of reduced cross-section between the inlet and outlet, a passage between the said zone and atmosphere, a control valve operable, when the main stream is to be to be dosed with a dosing liquid, to close the passage such that a relatively low pressure zone is generated in the zone when the main liquid stream flows from the first inlet to the outlet through the zone, a second inlet through which the dosing liquid can be drawn into the low pressure zone to mix with the main liquid stream and form a mixed stream, and an aerator, located in the conduit downstream of the venturi, to receive air through the outlet and introduce it into the mixed stream.

2. A dosing device according to claim 1 wherein the control valve includes a push-button depressible to seat a valve closure on a seat, thereby to close the passage.

3. A dosing device according to claim 2 wherein the push-button is spring-loaded in a sense to unseat the valve closure from the seat.

4. A dosing device according to claim any one of the preceding claims wherein the outlet is spanned, downstream of the aerator, by a mesh gauze.

5. A dosing device according to any one of the preceding claims wherein the second inlet includes an inlet spigot to which a conduit leading from a source of the dosing liquid can be connected, and a flow control nozzle which is fitted releasably to the inlet spigot to control the flow of dosing liquid therethrough and over which the conduit is connected to the spigot.

6. A dosing device according to any one of the preceding claims wherein the first inlet is threaded for connection to a faucet.

7. A dosing device according to claim 6 wherein the conduit is formed in body having an outer surface formed with spanner-engagable flats to facilitate threaded connection of the first inlet to the faucet.

8. A dosing device according to any one of the preceding claims wherein the second inlet includes a non-return valve.
